(19) United States
(12) Patent Application Publication
(10) Pub. No.: US 2022/0108338 A1
(43) Pub. Date: Apr. 7, 2022

(54) SYSTEMS AND METHODS FOR AN INTERACTIVE BIDDING PLATFORM FOR OPPORTUNITIES BASED ON LOCATION

(71) Applicant: Capital One Services, LLC, McLean, VA (US)

(72) Inventors: Vincent PHAM, Champaign, IL (US); Alvin S. HUA, Gaithersburg, MD (US); Ernest KWAK, Urbana, IL (US); Galen RAFFERTY, Mahomet, IL (US); Austin WALTERS, Savoy, IL (US); Anh TRUONG, Champaign, IL (US); Jeremy GOODSITT, Champaign, IL (US)

(73) Assignee: Capital One Services, LLC, McLean, VA (US)

(21) Appl. No.: 17/062,450

(22) Filed: Oct. 2, 2020

(51) Int. Cl. G06Q 30/02; G06Q 40/02; G06F 16/26

(52) U.S. Cl. CPC G06Q 30/0205; G06Q 30/0206; G06Q 40/02; G06Q 30/0275; G06F 16/26; G06Q 30/0261; G06Q 30/0254; G06Q 30/0269; G06Q 30/0252

(57) ABSTRACT

A computer-implemented method that includes presenting an available interaction opportunity based on a geolocation of an interaction platform and receiving proposals from one or more users for the available interaction opportunity at the geolocation. The method includes determining a successful proposal from the proposals received by the one or more users and displaying a stored interaction associated with a profile of a user of the one or more users having the successful proposal at the geolocation and on the interaction platform.

### TECHNICAL FIELD

Various embodiments of the present disclosure relate generally to an interactive bidding platform, and relate particularly to methods and systems for submitting proposals on interaction opportunities based on a location of an interaction platform for displaying interaction content (e.g., an advertisement).

### BACKGROUND

Securing rights to available opportunities (e.g., interaction opportunities) may generally require advanced planning and payment in anticipation of a prospective opportunity scheduled for a future date. For example, opportunities to share interaction content (e.g., advertisements) on a display platform with potential consumers require selecting a predefined location and designated time to display the content in anticipation of the customers' future whereabouts. By necessitating acquisition of the opportunity beforehand, the buyer acquiring rights to the opportunity assumes the risk of the advertisement not being displayed at an ideal location or time to reach the target consumer, thereby failing to provide the maximum possible return to the buyer. By marketing sale of the opportunity prior to its scheduled occurrence, the seller offering rights to the opportunity assumes the risk of forfeiting greater offers from prospective buyers seeking rights to the opportunity at the scheduled occurrence, thereby failing to provide the maximum possible return to the seller.

The present disclosure is directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure methods, systems, and non-transitory computer-readable media are disclosed for presenting and bidding on available interaction opportunities. Each of the examples disclosed herein may include one or more of the features described in connection with any of the other disclosed examples.

In one example, a computer-implemented method may include: presenting an available interaction opportunity based on a geolocation of an interaction platform; receiving proposals from one or more users for the available interaction opportunity at the geolocation; determining a successful proposal from the proposals received by the one or more users; and displaying a stored interaction associated with a profile of a user of the one or more users having the successful proposal at the geolocation and on the interaction platform.

In another example, a computer-implemented method may include: determining availability of an interaction opportunity at an interaction platform; providing an availability status of the interaction opportunity and a geolocation of the interaction platform to a plurality of users; receiving bids for the interaction opportunity by one or more active users from the plurality of users; determining a successful proposal from the proposals received from the one or more active users; and transmitting an interaction selected by an active user of the one or more active users having the successful proposal to the interaction platform for display.

In a further example, a system may include a processor, and a memory storing instructions that, when executed by the processor, causes the processor to perform operations including: presenting an available interaction opportunity based on a geolocation of an interaction platform; receiving proposals from one or more users for the available interaction opportunity at the geolocation of the interaction platform; determining a successful proposal from the proposals received by the one or more users; and displaying a stored interaction associated with a profile of a user of the one or more users having the successful proposal on the interaction platform.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary client-server environment that may be utilized according to aspects of the present disclosure.

FIG. 2 depicts an exemplary process for submitting proposals on an interaction opportunity based on a geolocation of an interaction platform for displaying the interaction.

FIG. 3 depicts an example of a computing device, according to aspects of the present disclosure.

### DETAILED DESCRIPTION OF EMBODIMENTS

The terminology used in this disclosure is to be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “computer system” generally encompasses any device or combination of devices, each device having at least one processor that executes instructions from a memory medium. Additionally, a computer system may be included as a part of another computer system.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially,” “approximately,” “about,” and “generally,” are used to indicate a possible variation of ±10% of a stated or understood value.

As used herein, the term “interaction opportunity,” “advertisement opportunity,” and/or “opportunity” may indicate, and may be used interchangeably with, any sale opportunity for securing present rights to use a display platform in real-time based on one or more locations of the platform, the buyer, the seller, the target users of the opportunity, and more. By way of illustrative example only, a sale opportunity may include displaying televised content, virtual gaming data, personal or business information, and various other suitable interaction materials for real-time display. It should be appreciated that the embodiments of the present disclosure may not be limited to physical display platforms, rather, the systems and methods disclosed herein may be applicable to various suitable devices, apparatuses, properties, assets, billboards, signs, virtual spaces, webpages, televised headlines, and the like without departing from a scope of this disclosure. The term “buyer” may indicate, and may be used interchangeably with, a user, a customer, an advertiser, a person attempting to obtain ownership of a service (e.g., an advertisement opportunity). The term “proposal” and “bid” may indicate, and may be used interchangeably with, any submission, offer, attempt, and/or request to secure rights to a sale opportunity.

In general, the present disclosure provides methods and systems for using machine learning techniques to host, administer, and facilitate a local bidding process for interaction opportunities, such as for advertisements, that are based at least in part on a geolocation of an interaction platform on which the interaction opportunity is to be displayed. As will be discussed in greater detail herein, existing techniques may be improved with the methods and systems of the present disclosure.

Advertisers seeking to market a good or service (collectively referred to herein as “products”) may desire purchasing opportunities to advertise said products on one or more display platforms having an optimal location for reaching target consumers. Additionally, advertisers may seek to present the advertisements in real-time when having knowledge of the target consumers' locations to maximize a potential benefit and/or return received from purchasing the advertisement opportunity. Accordingly, a need exists to provide a real-time ability to acquire rights for interaction (advertisement) opportunities.

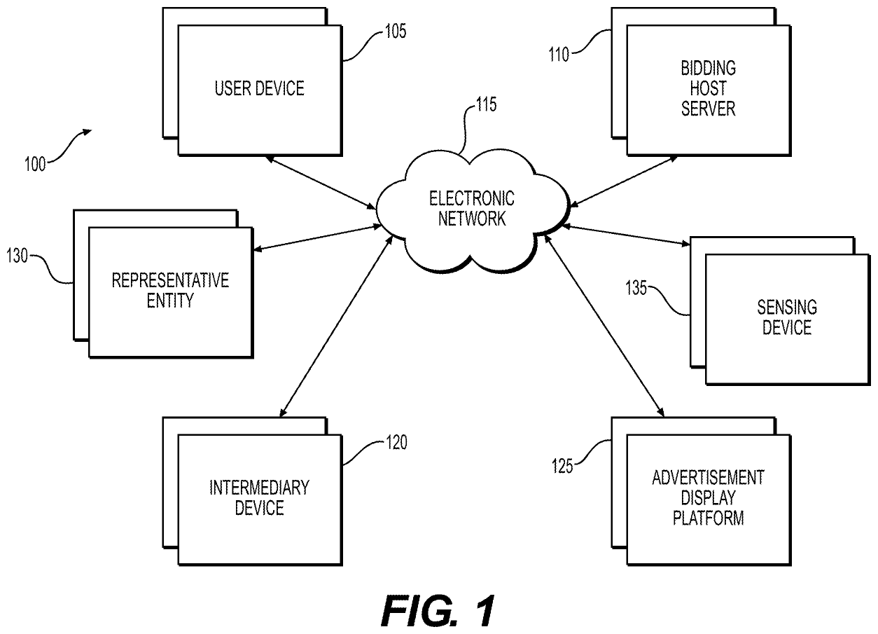

FIG. 1 depicts an exemplary client-server environment that may be utilized with techniques presented herein. For example, the environment may include a system 100 with one or more user devices 105, one or more bidding host servers 110, one or more intermediary devices 120, and one or more interaction display platforms 125 (also referred to herein as “advertisement display platforms”). It should be appreciated that system 100 may include a plurality of user devices 105 configured to access bidding host server 110, each of which may be associated with at least one user. In some embodiments, each of the plurality of users may have a profile registered on bidding host server 110 and including user data, such as funds for submitting proposals (e.g., bids). As described in further detail herein, the plurality of users may include one or more active users (e.g., bidders) and one or more inactive users for an interaction opportunity (also referred to herein as “advertisement opportunity”).

System 100 may further include one or more intermediary devices 120 configured to access bidding host server 110, each of which may be associated with at least one host user. In some embodiments, the one or more host users may be a host of an event at a venue (e.g., a conference, a meeting, a concert, a play, a wedding, a game, an exhibition, etc.) having one or more interaction opportunities for acquisition by prospective advertisers (e.g., the plurality of users). The venue (e.g., a working environment) may include the one or more advertisement display platforms 125 at various locations of the venue. For example, the one or more advertisement display platforms 125 may include a display screen, such as a television, a computer monitor, a mobile device, a projector, and the like. In other embodiments, the one or more advertisement display platforms 125 may include a virtual display space, such as, for example, a webpage. In other embodiments, the one or more host users may be an owner of property (e.g., a building, a facility, a transportation vehicle, a message board, a billboard, etc.) having one or more advertisement opportunities for display at advertisement display platforms 125 located on the property.

Still referring to FIG. 1, system 100 may further include one or more sensing devices 135 at various locations of the venue (e.g., a working environment), such as, for example, at the locations of the one or more advertisement display platforms 125. Sensing devices 135 may be configured to detect a presence of users (e.g., target consumers) at a location and/or to determine a quantity of users at said location (e.g., at the geolocation of advertisement display platform 125). In some embodiments, sensing devices 135 may be configured to associate the occupant data with a categorization of the occupants (e.g., target consumers) at the geolocation of advertisement display platforms 125 and/or an event categorization located at the geolocation of advertisement display platforms 125 during the advertisement opportunity. Sensing devices 135 may be configured to transmit the sensor data to bidding host server 110 via electronic network 115. In some embodiments, sensing devices 135 may include an imaging device, an infrared detector, a light switch, a photoelectric sensor, and more.

System 100 may further include one or more representative entities 130 having one or more representatives (e.g., employees). For example, at least one or more of the plurality of users may be representatives of the same representative entity 130. The user data stored in a profile of each of the plurality of users (on bidding host server 110) may include an identification of the representative entity 130 to which the user may belong to. In some embodiments, the plurality of representatives may be located at one or more locations, such as, for example, the venue of the host user. As described in greater detail herein, users of the same representative entity 130 may submit proposals (e.g., bids) in support of one another when seeking acquisition of an advertisement opportunity at the venue.

Still referring to FIG. 1, the one or more components of system 100 of FIG. 1 may communicate with one another across an electronic network 115 and in any arrangement. User device 105 may be associated with a user, such as, for example, an advertiser seeking to submit a bid for an advertisement opportunity based on a geolocation of advertisement display platform 125. Each of the plurality of users may access the one or more other components of system 100 via user device 105, such as, for example, via an electronic application (e.g., a text messaging application, an e-commerce application, a social media application, or the like), an internet browser extension, or a website page.

The users may conduct one or more operations of the present disclosure, such as, for example, viewing available advertisement opportunities at one or more advertisement display platforms 125, submitting a proposal for an advertisement opportunity (e.g., an active bidder), sharing funds and contributing to a proposal of another user from the same representative entity 130 (e.g., an inactive bidder), and more via user device 105. As described in greater detail herein, the plurality of users may further access, review, and/or modify one or more proposals via user device 105, such as, for example, proposal specifications defining a payment value, an advertisement duration, and a display region of advertisement display platform 125.

One or more of user device(s) 105, bidding host server 110, intermediary device(s) 120, advertisement display platform(s) 125, and/or sensing device(s) 135 may communicate with each other over electronic network 115 in executing a machine learning model to process bids for an advertisement opportunity based on a geolocation of the advertisement opportunity. It should be appreciated that the term “geolocation” and/or “location” may include various forms of detail, data, or information (e.g., latitude and longitude coordinates) relating to a relative location of the advertisement opportunity relative to an environment (e.g. the venue). As used herein, a “machine learning model” may include data (e.g., user data, advertisement data, location data, or bid data) or instruction(s) for generating, retrieving, and/or analyzing such data.

Still referring to FIG. 1, electronic network 115 may be a wide area network (“WAN”), a local area network (“LAN”), personal area network (“PAN”), or the like. In some embodiments, electronic network 115 includes the Internet, and information and data provided between various components of system 100 may occur online. “Online” may mean connecting to or accessing source data or information from a location remote from other devices or networks coupled to the internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). In other embodiments, electronic network 115 may be a telecommunications network, such as, for example, a telephone network, cellular network, or the like, or combinations thereof. In some embodiments, a text messaging channel may be embedded into, linked with, or configured to operate in conjunction with an electronic application operating on user device 105 and/or on electronic network 115.

While FIG. 1 depicts the various components of system 100 as physically separate and communicating across network 115, it should be appreciated that in other embodiments one or more components of system 100 may be incorporated partially or completely into any of the other components shown in FIG. 1. Some or all of the functionality of the machine learning model may be incorporated into one or more components of system 100, such as, for example, bidding host server 110, intermediary device 120, etc. Some or all of the functionality of bidding host server 110, intermediary device 120, advertisement display platform 125, and/or sensing device 135 may be accessible via user device 105 and incorporated into a text messaging application, an internet browser extension, or website page.

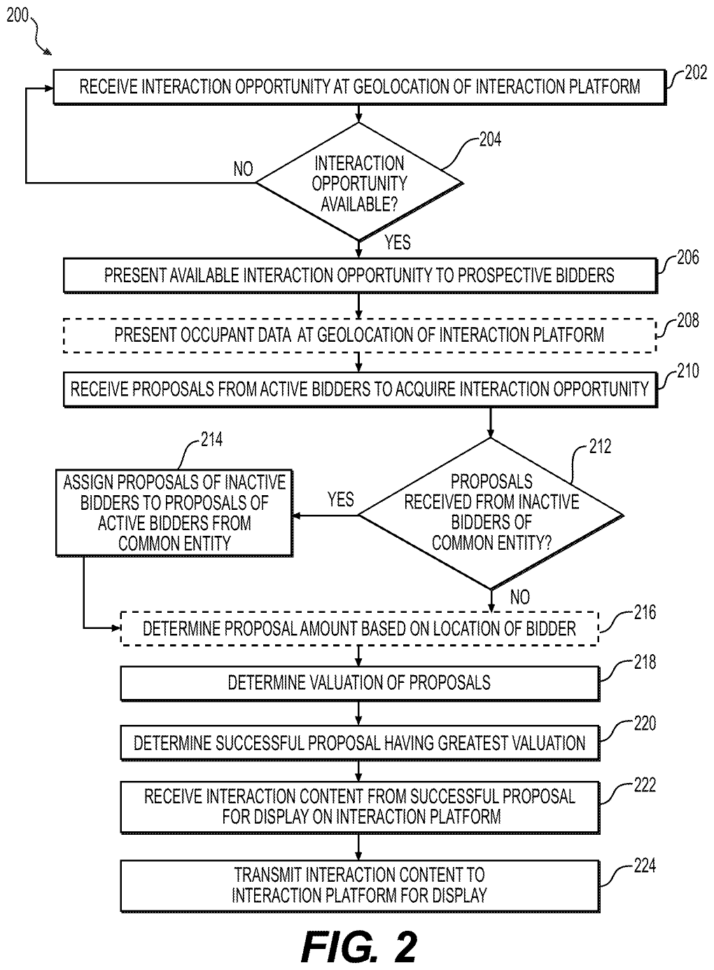

FIG. 2 illustrates an exemplary process 200 for determining a successful proposal for an interaction opportunity in accordance with embodiments of the present disclosure. It should be understood that the steps described herein, and the sequence in which they are presented, are merely illustrative such that additional and/or fewer steps may be included without departing from the scope of the present disclosure.

At step 202, system 100 may be configured to receive one or more advertisement opportunities based on a geolocation of one or more advertisement display platforms 125. It should be appreciated that the advertisement opportunities may be received by system 100 from a host user(s) providing the advertisement opportunities. Stated differently, system 100 may retrieve one or more advertisement opportunities created by a host user(s), and the one or more advertisement opportunities may be defined by a geolocation of an advertisement display platform 125 to display the advertisement opportunity. Bidding host server 110 may store a plurality of advertisement opportunities thereon and may provide all and/or a subset of the plurality of advertisement opportunities to the one or more users of system 100. In some embodiments, bidding host server 110 may receive instructions from a host server (e.g., via intermediary device 120) to provide one or more of the plurality of advertisement opportunities. Stated differently, bidding host server 110 may include a list of active advertisement opportunities and a list of inactive advertisement opportunities. As described in further detail herein, each of the advertisement opportunities on the list of active advertisement opportunities may further include an availability status (e.g., available, unavailable, etc.) indicating whether the advertisement opportunity is open for proposals.

In some embodiments, each advertisement display platform 125 may offer at least one advertisement opportunity; while in other embodiments, each advertisement display platform 125 may offer a plurality of advertisement opportunities. For example, each advertisement display platform 125 may include a single display screen having one or more regions, portions, quadrants, sections, etc., each of which may offer an advertisement opportunity. In other examples, each advertisement display platform 125 may include a plurality of display screens at a single geolocation. It should be appreciated that the one or more advertisement opportunities may be defined based on a geolocation of advertisement display platforms 125.

A current status of the advertisement opportunities, advertisement display platforms 125, and respective geolocations of the advertisement display platforms 125 may be stored on bidding host server 110. At step 204, system 100 may be configured to determine an availability of the one or more advertisement opportunities. The plurality of users may review the list of advertisement opportunities provided by bidding host server 110 via user device 105, including details regarding a status of the advertisement opportunity and a geolocation of the advertisement display platform 125 for hosting the advertisement opportunity. In response to determining an availability of an advertisement opportunity at step 204, system 100 may be configured to present the available advertisement opportunity to prospective bidders at step 206.

In this instance, bidding host server 110 may communicate with the plurality of users via user devices 105 to transmit information relating to the available advertisement opportunity. For example, the information communicated to user device(s) 105 at step 206 may include an updated status of the advertisement opportunity, a geolocation of the advertisement display platform 125, details relating to advertisement display platform 125 (e.g., a type, a format, a size, a shape, a resolution, a technology, etc.), a minimum and/or maximum proposal amount for the advertisement opportunity, a current proposal amount, a remaining proposal duration, a list of active bidders, a list of inactive bidders, an applicable advertisement opportunity restriction, and more. In some embodiments, occupant information detected by sensing device(s) 135 (e.g., sensor data) may be communicated to user device(s) 105 at step 208. For example, the sensor data may include an occupancy count of target consumers at the geolocation of the advertisement display platform 125 associated with the available advertisement opportunity. It should be appreciated that, in other embodiments, step 208 may be optional such that system 100 may omit transmitting the occupant information (e.g., sensor data) entirely.

Still referring to FIG. 2, system 100 may be configured to receive one or more proposals (e.g., a plurality of bids) from one or more users (e.g., active bidders) at step 210. In some embodiments, bidding host server 110 may receive proposals from user devices 105 for the available advertisement opportunity based on a geolocation of advertisement display platform 125. Stated differently, the advertisement opportunity may be defined at least partly based on a geolocation of the advertisement display platform 125 such that the proposals may be directed to securing rights at the geolocation of the advertisement display platform 125 on which the advertisement opportunity is available. It should be appreciated that bidding host server 110 may simultaneously receive proposals for different advertisement opportunities that may be available concurrently with one another. It should further be appreciated that each of the proposals may define various specifications that may vary relative to the other proposals received for the same advertisement opportunity.

For example, each proposal may specify one or more specifications defining a parameter of the proposal. The one or more proposal specifications may include, but is not limited to, a payment value of the proposal, an advertisement duration of the proposal, an advertisement content, and a display region of advertisement device platform 125. The payment value may define a financial amount for the proposal. The advertisement duration may define a desired time for which the bidder seeks to obtain rights relating to the advertisement opportunity. The display region may define a desired quadrant, section, and/or portion of advertisement device platform 125 for which the bidder seeks to obtain rights relating to the advertisement opportunity. As described in detail above, in some embodiments the advertisement device platform 125 may include multiple regions for advertisement opportunities. In this instance, the proposal specification may define one or more particular regions of the advertisement device platform 125. In other embodiments the advertisement device platform 125 may include a single interface for displaying an advertisement opportunity.

In some embodiments, bidding host server 110 may be configured to receive instructions from a host user (e.g., via intermediary device 120) to accept, ignore, and/or modify one or more proposals received from the active bidders. For example, bidding host server 110 may receive a signal transmitted from intermediary device 120 indicative of a user input from the host user to disregard proposals from one or more particular active bidders, for one or more advertisement opportunities, and/or from bidders of one or more representative entities 130. In further example, bidding host server 110 may receive instructions from intermediary device 120 to reveal and/or obfuscate the one or more proposals received at step 210 to the public (e.g., other users of system 100).

Still referring to FIG. 2, in addition to the proposals received from active bidders at step 210, system 100 may be configured to receive one or more proposal contributions from one or more inactive bidders at step 212. In this instance, bidding host server 110 may receive proposals from inactive bidders (e.g., via user devices 105) for contribution toward a preexisting proposal received from at least one active bidder at step 210. In some embodiments, the user may specify the proposal as a contribution by including one or more proposal specifications (e.g., a bid categorization) designating the proposal as such. Further, the user may specify the particular preexisting proposal in which the proposal contribution is to be directed toward via the one or more proposal specifications. For example, the proposal specification may designate an identification of the preexisting proposal, the active bidder, and/or the advertisement opportunity at the geolocation of the advertisement display platform 125.

Bidding host server 110 may be configured to permit proposal contributions from inactive bidders to particular proposals of active bidders when the inactive bidders are representatives of a common representative entity 130 as the active bidder. In this instance, the inactive bidders may identify the active bidder they seek to share funds with and/or designate the preexisting proposal to which they seek to contribute toward. Bidding host server 110 may be configured to determine a commonality between the representative entity 130 that the inactive bidder belongs to relative to the representative entity 130 that the active bidder belongs to at step 212, prior to assigning the proposal contribution to the preexisting proposal at step 214. In some embodiments, bidding host server 110 may analyze a registered profile (e.g., user data) of the inactive bidder to identify a designation of the representative entity 130 to which the inactive bidder belongs. Further, bidding host server 110 may compare the designation to the registered profile of the active bidder that the proposal contribution is directed toward to confirm whether the active bidder and the inactive bidder represent a common representative entity 130.

In other embodiments, bidding host server 110 may automatically assign any proposal contributions received from inactive bidders (step 212) to any preexisting proposals of active bidders (step 210) having a common representative entity 130, at step 214. In this instance, bidding host server 110 may be configured to detect a registered profile of the inactive bidders relative to the registered profiles of the active bidders (e.g., stored on bidding host server 110) having submitted proposals. Bidding host server 110 may determine the corresponding proposal (from step 210) that each contribution (from step 212) is to be assigned to upon identifying which inactive bidders represent a common representative entity 130 as the active bidders. In this instance, the funds of the proposal contributions are automatically assigned to the preexisting proposals without necessitating a designation of the preexisting proposal and/or the active bidder. Bidding host server 110 may aggregate the funds to form a total proposal from the common representative entity 130.

In some embodiments, bidding host server 110 may be configured to receive instructions from a host user (e.g., via intermediary device 120) to accept, ignore, and/or modify one or more contributory proposals received from the inactive bidders. For example, bidding host server 110 may receive a signal transmitted from intermediary device 120 indicative of a user input from the host server to limit contributory proposals to preexisting proposals up to a predetermined threshold. In further example, bidding host server 110 may receive instructions from intermediary device 120 to reveal and/or obfuscate the one or more contributory proposals received at step 212 to the public (e.g., other users of system 100).

Still referring to FIG. 2, and at step 216, system 100 may be configured to determine an amount of each of the proposals (from steps 210 and 212) based on a location of the bidder (e.g., active and inactive) when receiving the proposal. For example, bidding host server 110 may be configured to receive location data with each of the proposals (e.g., from user device 105) designating a current location of the bidder when submitting the proposal. Accordingly, a payment value of the proposal may be dynamically adjusted based on the location of the bidder. In some embodiments, the payment value of the proposal may be relatively greater when the bidder is located proximate to a geolocation of the advertisement platform 125 (e.g., within a predefined vicinity), and relatively smaller when the bidder is positioned further away from the advertisement platform 125 (e.g., outside the predefined vicinity).

In other embodiments, the payment value of the proposal may be relatively greater when the bidder is located proximate to a location of other bidders (e.g., within a predetermined threshold), and relatively smaller when the bidder is located further away from other bidders (e.g., outside the predetermined threshold). It should be appreciated that the dynamic payment values of the proposals may be determined by various other suitable relationships of a bidder's location. It should be appreciated that, in other embodiments, step 216 may be optional such that system 100 may determine a static payment value of the proposal irrespective of the bidder's location.

At step 218, system 100 may be configured to determine an overall valuation of each of the one or more proposals received from the bidders. Bidding host server 110 may compute the overall valuation of each of the proposals based on the one or more proposal specifications of each of the proposals, including the cumulative payment value, the advertisement duration, the advertisement content, and/or the display region of advertisement device platform 125. For example, bidding host server 110 may be configured to assign a score, a weighted factor, and/or a multiplier to each of the one or more proposal specifications for determining the overall valuation.

In some embodiments, the host user may determine a value of the score, the weighted factor, and/or the multiplier for each of the one or more proposal specifications via one or more inputs received from intermediary device 120. It should be appreciated that the corresponding values for each of the proposal specifications may vary relative to the advertisement opportunity. By way of example, a proposal specification (e.g., the cumulative payment value, the advertisement duration, the advertisement content, and/or the display region of advertisement device platform 125) may have a first value (e.g., score, weighted factor, multiplier, etc.) assigned for a first advertisement opportunity, while the same proposal specification may have a second value assigned, that is different than the first value, for a second advertisement opportunity. In other embodiments, bidding host server 110 may be configured to automatically assign a value for the score, the weighted factor, and/or the multiplier for each of the proposal specifications based on the advertisement opportunity, a geolocation of advertisement device platform 125, a location of the bidder, and more.

Still referring to FIG. 2, system 100 may be configured to determine a successful proposal (e.g., a winning bid) from the one or more proposals at step 220. Bidding host server 110 may identify the proposal having the greatest valuation upon computing the overall valuations of each of the proposals (step 218) and comparing the overall valuations of each proposal relative to one another. In some embodiments, bidding host server 110 may be configured to determine a single successful proposal for each advertisement opportunity. In other embodiments, bidding host server 110 may be configured to determine two or more successful proposals for each advertisement opportunity.

Bidding host server 110 may be configured to communicate with the user(s) having the successful proposal (e.g., via user device 105). In some embodiments, bidding host server 110 may transmit a notification to the active bidder of the successful proposal; while in other embodiments, bidding host server 110 may transmit the notification to the active bidder and any inactive bidders contributing toward the successful proposal. It should be appreciated that system 100 may be configured such that bidding host server 110 is agnostic to a form of currency. Accordingly, the valuations of each of the proposals may be in the form of government-issued currency, virtual coins, tokens, points, etc.

At step 222, system 100 may be configured to receive an interaction content (e.g., advertisement material) from the active bidder of the successful proposal. The interaction content may be preselected by the active bidder as one of the proposal specifications received with the proposal at step 210. Alternatively, the interaction content may be received from the active bidder upon determining the successful proposal at step 220. In some embodiments, the content may be selected by the active bidder and any inactive bidder(s) contributing toward the successful proposal. It should be appreciated that one or more interaction content may be stored on bidding host server 110, such as, for example, in the registered profile of the user. Accordingly, the bidder having the successful proposal may select the interaction content for display on advertisement platform 125 from the one or more interaction content stored on bidding host server 110. Bidding host server 110 may receive the selection of the stored interaction content via a user input from the bidder having the successful proposal (e.g., via user device 105).

In some embodiments, bidding host server 110 may be configured to receive instructions from a host user (e.g., via intermediary device 120) to accept, deny, and/or modify the content received from the successful bidders. For example, bidding host server 110 may receive a signal transmitted from intermediary device 120 indicative of a user input from the host server to reject the interaction (advertisement) content selected by the successful bidder (e.g., identified as unsafe, inappropriate, defamatory, etc.) and prompt for selection of another content (e.g., via communication with user device 105).

At step 224, upon receiving the interaction content at step 222, system 100 may be configured to transmit the content to advertisement platform 125 for display at the geolocation of the venue. Bidding host server 110 may be configured to fetch the interaction content from the registered profile of the successful bidder and display the content on advertisement platform 125. Bidding host server 110 may further update a status of the advertisement opportunity (e.g., unavailable) such that further proposals for the advertisement opportunity at the geolocation of advertisement platform 125 are prevented.

Accordingly, system 100, in executing process 200 shown and described above, may provide an interactive platform for hosting and presenting a plurality of interaction opportunities to prospective bidders. The interaction opportunities may be based on a geolocation of one or more interaction platforms on which the interaction opportunity (e.g., an opportunity to share an advertisement) is to be displayed. Accordingly, system 100 may facilitate a real-time bidding process of an opportunity to display an advertisement at a geolocation of an advertisement platform.

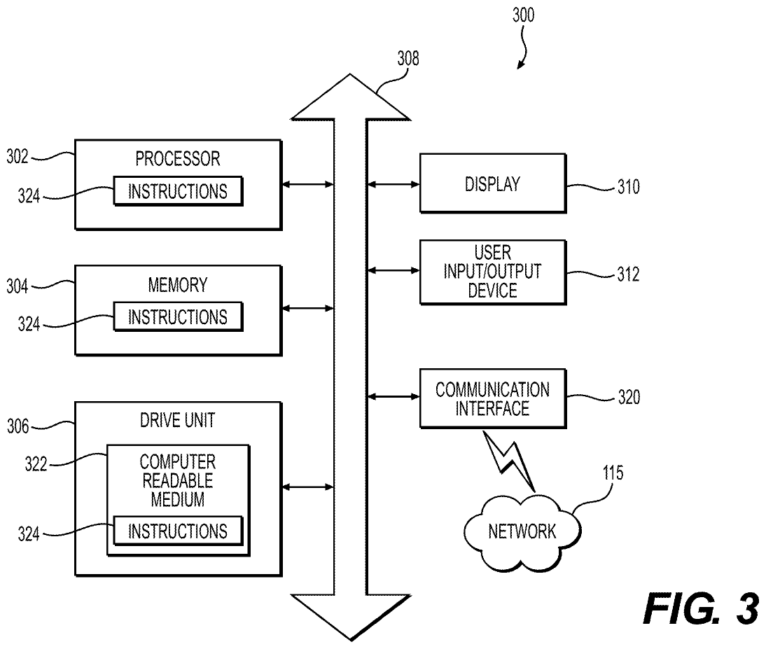

FIG. 3 is a simplified functional block diagram of a computing device 300 that may be configured as a device for executing the methods of FIG. 2, according to exemplary embodiments of the present disclosure. Any of the devices, databases (e.g., servers), processors, etc. of system 100 discussed herein may be an assembly of the hardware of computing device 300 including, for example, user device 105, bidding host server 110, intermediary device 120, advertisement display platform 125, and/or sensing device 135, according to exemplary embodiments of the present disclosure.

Computing device 300 may include a central processing unit (“CPU”) 302 that may be in the form of one or more processors configured to execute program instructions, such as those of process 200 described in detail above. In some embodiments, the processor(s) of CPU 302 includes both a CPU and a GPU. Computing device 300 may further include a storage unit 306 that may include non-volatile memory, such as, for example, a storage media (e.g., solid-state drives), ROM, HDD, SDD, etc. Examples of storage media include solid-state storage media (e.g., solid state drives and/or removable flash memory), optical storage media (e.g., optical discs), and/or magnetic storage media (e.g., hard disk drives). Storage unit 306 may store data on a computer readable medium 322. In some embodiments, computing device 300 may receive programming and data via network communications from electronic network 115, such as, for example, via a communication interface 320 configured to communicate with one or more other components of system 100.

Still referring to FIG. 3, computing device 300 may include a memory 304 that is volatile memory, such as, for example, RAM, solid-state memories, optical storage media (e.g., optical discs), magnetic storage media (e.g., hard disk drives), etc. Memory 304 may be configured for storing one or more instructions 324 for executing techniques presented herein, such as those of process 200 shown and described above. Memory 304 may further include a non-transitory computer-readable medium. Therefore, whenever a computer-implemented method is described in this disclosure, this disclosure shall also be understood as describing a non-transitory computer-readable medium storing instructions that, when executed by one or more processors (e.g., CPU 302), cause the one or more processors to perform the computer-implemented method.

In some embodiments, the one or more instructions 324 may be stored temporarily or permanently within other modules of computing device 300, such as, for example, CPU 302, computer readable medium 322, and more. Computing device 300 may include an input/output device 312 including one or more input ports and one or more output ports. Input/output device 312 may include, for example, a keyboard, a mouse, a touchscreen, etc. (i.e., input ports). Input/output device 312 may further include a monitor, a display, a printer, etc. (i.e. output ports). Computing device 300 may further include a display device 310 configured to connect with input/output device 312. The aforementioned elements of computing device 300 may be connected to one another through an internal communication bus 308, which represents one or more busses.

In other embodiments, the various system functions of process 200 shown in FIG. 2 may be implemented in a distributed fashion on a number of similar platforms to distribute the processing load on multiple computing devices 300. Alternatively, the system functions may be implemented by appropriate programming of one computer hardware platform, such as, for example, computing device 300.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming.

All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data, it should be appreciated that the presently disclosed embodiments may be applicable to any environment, such as a desktop or laptop computer. Also, the presently disclosed embodiments may be applicable to any type of Internet protocol. It is intended that the specification and examples be considered as exemplary only, with a true scope and spirit of the disclosure being indicated by the following claims.

In general, any process discussed in this disclosure that is understood to be performable by a computer may be performed by one or more processors. Such processes include, but are not limited to, the process shown in FIG. 2, and the associated language of the specification. The one or more processors may be configured to perform such processes by having access to instructions (computer-readable code) that, when executed by the one or more processors, cause the one or more processors to perform the processes. The one or more processors may be part of a computer system (e.g., one of the computer systems discussed above) that further includes a memory storing the instructions. The instructions also may be stored on a non-transitory computer-readable medium. The non-transitory computer-readable medium may be separate from any processor. Examples of non-transitory computer-readable media include solid-state memories, optical media, and magnetic media.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above-disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method, comprising:
presenting an interaction opportunity based on a geolocation of an interaction platform;
receiving proposals from one or more users for the interaction opportunity at the geolocation;
determining a successful proposal from the proposals received by the one or more users; and
displaying a stored interaction associated with a profile of a user of the one or more users having the successful proposal at the geolocation and on the interaction platform.

2. The computer-implemented method of claim 1, wherein receiving proposals from the one or more users further comprises:
receiving a signal from a user device of the one or more users, the signal including one or more proposal specifications.

3. The computer-implemented method of claim 2, wherein the one or more proposal specifications include a payment value, an interaction duration, and a display region of the interaction platform.

4. The computer-implemented method of claim 3, wherein determining the successful proposal further comprises:
determining a valuation of the proposals received by the one or more users based on a comparison of the payment value, the interaction duration, and the display region of the proposals, wherein the successful proposal includes the proposal having a greatest valuation.

5. The computer-implemented method of claim 1, further comprising, prior to determining the successful proposal from the proposals received by the one or more users,
determining an amount of each of the proposals from the one or more users based on a location of the user when receiving the proposals.

6. The computer-implemented method of claim 5, wherein the amount of each of the proposals is dynamically adjusted based on the location of the user relative to the geolocation of the interaction platform.

7. The computer-implemented method of claim 1, further comprising, prior to displaying the stored interaction on the interaction platform,
receiving a selection of the stored interaction from a plurality of stored interactions associated with the profile of the user having the successful proposal.

8. The computer-implemented method of claim 1, wherein the profile of the one or more users are each associated with at least one representative entity.

9. The computer-implemented method of claim 8, wherein receiving proposals from the one or more users further comprises:
sharing funds stored on the profile of the one or more users between users associated with a common representative entity.

10. The computer-implemented method of claim 8, wherein determining the successful proposal further comprises:
accumulating funds shared by the one or more users from a common representative entity for comparison to the proposals from users of other representative entities.

11. The computer-implemented method of claim 8, wherein receiving proposals from the one or more users further comprises:
determining an amount of the proposals from users associated with a common representative entity based on a location of the users relative to the interaction platform and to one another.

12. The computer-implemented method of claim 1, wherein the geolocation of the interaction platform is relative to a working environment including at least a second interaction platform having a second geolocation within the working environment that is different than the geolocation of the interaction platform.

13. The computer-implemented method of claim 1, wherein the interaction platform includes one or more display regions for displaying the stored interaction; and
wherein the interaction platform includes a display screen of a television, a projector, a mobile device, a computer, or a webpage.

14. The computer-implemented method of claim 1, further comprising:
determining occupant data at the geolocation of the interaction platform; and
providing the occupant data to the one or more users when presenting the available interaction opportunity.

15. The computer-implemented method of claim 14, wherein the occupant data includes a quantity of occupants at the geolocation, a categorization of the occupants at the geolocation, or an event categorization located at the geolocation.

16. A computer-implemented method, comprising:
determining availability of an interaction opportunity at an interaction platform;
providing an availability status of the interaction opportunity and a geolocation of the interaction platform to a plurality of users;
receiving proposals for the interaction opportunity by one or more active users from the plurality of users;
determining a successful proposal from the proposals received from the one or more active users; and
transmitting an interaction selected by an active user of the one or more active users having the successful proposal to the interaction platform for display.

17. The computer-implemented method of claim 16, wherein the plurality of users includes the one or more active users and one or more inactive users, and the method further comprises:
receiving a proposal contribution from at least one of the one or more inactive users towards the proposal of at least one of the one or more active users.

18. The computer-implemented method of claim 17, further comprising:
accumulating the at least one proposal contribution to the proposal of the at least one active user to determine a total proposal received by the at least one active user.

19. The computer-implemented method of claim 17, wherein the at least one inactive user is limited to providing the proposal contribution toward the proposal of at least one of the one or more active users that has a profile associated with a common representative entity as the inactive user.

20. A system, comprising:
a processor; and
a memory storing instructions that, when executed by the processor, causes the processor to perform operations including:
presenting an available interaction opportunity based on a geolocation of an interaction platform;
receiving proposals from one or more users for the available interaction opportunity at the geolocation of the interaction platform;
determining a successful proposal from the proposals received by the one or more users; and
displaying a stored interaction associated with a profile of a user of the one or more users having the successful proposal on the interaction platform.
